(19) United States
(12) Patent Application Publication
(10) Pub. No.: US 2025/0234141 A1
(43) Pub. Date: Jul. 17, 2025

(54) Charging arrangement for charging a hearing aid

(71) Applicant: SONOVA AG, Staefa (CH)

(72) Inventors: Andre Ochsenbein, Wolfhausen (CH); Sven Keller, Wila (CH); Mika Ilvonen, Guelph (CA)

(21) Appl. No.: 19/016,676

(22) Filed: Jan. 10, 2025

(30) Foreign Application Priority Data
Jan. 12, 2024 (CH) CH000036/2024

(51) Int. Cl. H04R 25/00; H02J 7/00

(52) U.S. Cl. CPC H04R 25/556; H02J 7/0045; H02J 7/0047; H04R 2225/31

(57) ABSTRACT

A charging arrangement for charging a hearing aid by means of a charger includes a first charging interface and a second charging interface which are designed for releasable mutual coupling in a plurality of coupling positions; and an indicator light configured to indicate a charging state of the hearing aid when the hearing aid is coupled to the charger. The first charging interface includes a plurality of charging contacts which comprise an at least single-break contact ring which forms one or more outer charging contacts, and which have a central charging contact which is arranged in a central region of the contact ring. The second charging interface includes contact pins which comprise a central contact pin and at least two outer contact pins arranged at the same distance from the central contact pin.

### RELATED APPLICATIONS

The present application claims priority to CH Patent Application No. CH000036/2024, filed Jan. 12, 2024, which is hereby incorporated by reference in its entirety.

### BACKGROUND INFORMATION

In the present context, hearing aids include both pure hearing aids to compensate for a functional deficit of the hearing organ and headphones or so-called “hearables” or smart headphones/earphones, which usually allow a wireless connection to peripheral devices such as a cell phone or an external microphone.

Modern hearing aids, in particular in-the-ear hearing aids (ITE), are equipped with rechargeable batteries or accumulators for their power supply. For charging, for example, chargers are used in which two or more electrical contacts are intended to transmit power from the charger to the hearing aid. Usually, the hearing aid must assume a certain position and/or a certain angle relative to the charger. This is particularly relevant if the hearing aid has a custom molded housing and thus an individual outer shape. However, connecting the hearing aid to the charger in a predetermined orientation or in a predetermined coupling position can require considerable dexterity, especially with miniaturized in-the-ear hearing aids. There is therefore a need for a hearing aid, e.g. a hearing aid with an irregular, in particular with a customer-specific, housing shell, to be able to be coupled to a charger for charging in several different coupling positions, e.g. in different rotational positions.

It is known to insert standardized, rechargeable behind-the-ear (BTE) hearing aids in a fixed position in a predetermined slot of a charger, where they are held in place by one or more magnets and charged via two or more fixed contacts.

US 2022/0109924 A1 describes a system comprising a hearing aid that includes a rechargeable voltage source, a power management circuit, and a first charging interface that includes a first cathode contact and a first anode contact that is spaced apart from the first cathode contact. A charging module comprises a second charging interface configured to be removably coupled to the first charging interface of the hearing aid. The second charging interface includes a second anode contact having a contact area and a displaceable second cathode contact. An arrangement is configured to displace at least a portion of the second cathode contact across the contact area to facilitate electrical contact between the first and second cathode contacts before electrical contact between the first and second anode contacts. The charging circuit of the charging module is coupled to the second charging interface and configured to charge the rechargeable voltage source of the hearing aid.

### BRIEF DESCRIPTION OF THE DRAWINGS

Examples of the invention are explained in more detail below on the basis of drawings. These show:

FIG. 1: a schematic view of a cover plate blank for a cover plate of a hearing aid,

FIG. 2: a schematic view of a first charging interface,

FIG. 3: a schematic detailed view of a charger with a second charging interface,

FIG. 4: a schematic detailed view of the hearing aid with the first charging interface, wherein the cover plate is not shown,

FIG. 5: a schematic cross-sectional view of the charger with the hearing aid, wherein the first charging interface is coupled to the second charging interface, and

FIG. 6: a schematic view of an embodiment of a contact ring on a carrier ring;

FIG. 7: a schematic view of a charging cable of a portable charger comprising a charging interface of a charging arrangement,

FIG. 8: a schematic view of a further embodiment of a charging cable of a portable charger, comprising a charging interface of a charging arrangement,

FIG. 9: a schematic view of one of the coupling parts of the charging cable of FIG. 7 with a hearing aid provided for coupling,

FIG. 10: a schematic view of one of the coupling parts of the charging cable of FIG. 8,

FIG. 11: a schematic view of a further embodiment of a portable charger, comprising a coupling part designed as a base plate, in a plan view,

FIG. 12: a schematic side view of the portable charger of FIG. 11.

Parts corresponding to one another are provided with the same reference signs in all figures.

### DETAILED DESCRIPTION

Described herein are charging arrangement for charging a hearing aid, as well as to a hearing aid and a charger.

The embodiments described herein are based on the task of specifying a charging arrangement for charging a hearing aid that overcomes the disadvantages of the prior art. In particular, a charging arrangement for charging a hearing aid is to be provided that allows reliable electrical contact between a hearing aid and a charging device and is easy to use. Furthermore, the embodiments described herein are intended to provide a hearing aid and a charging device that are designed for use in such a charging arrangement.

A charging arrangement for charging a hearing aid by means of a charger comprises a first charging interface and a second charging interface, which are designed for the detachable coupling to one another in several coupling positions. In particular, the first and second charging interfaces are designed for the releasable coupling of a hearing aid provided with one of the charging interfaces to a charging device provided with the other of the charging interfaces. The first charging interface comprises a plurality of charging contacts, which comprise an at least once interrupted contact ring forming one or more outer charging contacts and which comprise a central charging contact arranged in a central area of the contact ring. The second charging interface has contact pins which comprise a central contact pin and at least two outer contact pins arranged at the same distance from the central contact pin. The contact pins are arranged in relation to one another in such a way that, in each coupling position, the central contact pin makes electrical contact with the central charging contact of the first charging interface, while at least one of the two outer contact pins of the second charging interface simultaneously makes electrical contact with at least one of the outer charging contacts of the first charging interface.

Charging of the hearing aid generally refers in this context to the performance of a charging process in which a rechargeable electrical voltage source of the hearing aid is charged by an external electrical voltage source, i.e. for example a charging device.

In one embodiment of the charging arrangement, the first charging interface can be formed on and/or in an outer side of a cover plate (on a so-called “faceplate”) of a hearing aid, while the second charging interface can be formed on a charging device. In other embodiments, the first charging interface can be formed on the charging device and, correspondingly, the second charging interface can be formed on the hearing aid. The charging interface on the hearing aid can also be arranged on the hearing aid at a location other than the cover plate and can, for example, be arranged in and/or on the outside of a housing wall, such as a housing shell. The charging arrangement can thus also be part of a system consisting of a hearing aid and a charging device, wherein the first and second charging interfaces are formed on the hearing aid and on the charging device, or vice versa.

The coupling position is understood to be an arrangement of the first charging interface relative to the second charging interface, in which the first charging interface is coupled to the second charging interface for the purpose of performing a charging operation. In some examples, the first and second charging interfaces can be coupled to one another in several different coupling positions. The first and second charging interfaces are designed in such a way that the electrical contact of the contact pins with the charging contacts required for charging the hearing aid is ensured in each of the intended coupling positions.

The coupling is releasable, i.e. the mutual coupling of the first and second charging interfaces is intended to be established and released by a user of the charging arrangement, or of the hearing aid and the charger, when used as intended. In particular, the coupling can be established to carry out the charging process and released or disconnected after the charging process.

The plurality of coupling positions can denote a plurality of rotational positions about a characteristic imaginary axis of the charging arrangement. The characteristic imaginary axis can be predetermined, for example, by a structurally distinguished direction of the charging arrangement, such as an axis of symmetry, a specific surface normal of a coupling and/or contact surface, an imaginary longitudinal axis of a coupling socket or an alignment of the contact pins of the second charging interface. In particular, the characteristic imaginary axis can be defined by a connection direction which designates a direction in which the first and second charging interfaces can be brought together for coupling. The plurality of coupling positions includes, for example, a plurality of relative rotational positions of the charging interfaces with respect to the connection direction. The connection direction can coincide with an alignment of the contact pins, i.e. with an alignment of the longitudinal axis of the contact pins, in particular of the central contact pin, of the second charging interface.

The contact ring is designed as an at least singly interrupted circular ring. In the case of a singly interrupted circular ring, the contact ring forms exactly one outer charging contact. In other embodiments, the contact ring is formed by a twice, three times or more frequently interrupted circular ring, so that a corresponding number of outer charging contacts results. It may be advantageous to choose an odd number of interruptions or charging contacts, for example, to avoid an unfavorable symmetry for a symmetrical arrangement of the contact pins.

In one embodiment, the first charging interface has an odd number of outer charging contacts and the second charging interface has an even number of outer contact pins. In another embodiment, the first charging interface has an even number of outer charging contacts and the second charging interface has an odd number of outer contact pins. In one embodiment, the contact ring is interrupted exactly three times so that it forms three outer charging contacts that are, in particular, regularly distributed and of equal size. In this embodiment, the second charging interface may include exactly two outer contact pins, which are arranged in a row with the central contact pin, i.e. the central contact pin is flanked by the two outer contact pins on either side.

Since the outer charging contacts are formed by the interrupted contact ring, each of the outer charging contacts can be formed by an annular sector.

Depending on the requirements, it may be advantageous for several outer charging contacts to be arranged uniformly over the circumference of the contact ring, so that the outer charging contacts are of equal size. In this case, the outer charging contacts can be formed by ring sectors of equal size. In one embodiment, the interruptions can also be distributed unevenly over the circumference of the contact ring, so that the outer charging contacts are of unequal size.

The charging contacts can have end contact surfaces for electrical contact with the contact pins of the second charging interface. In one embodiment, the contact surfaces of the charging contacts are designed as flat end faces, whereby the flat end faces of the individual charging contacts can be aligned parallel to one another. The contact surfaces can also be designed in a recess-shaped manner, i.e. they can be curved concavely, for example, in order to enable a more stable contact with the contact pins of the second charging interface. The contact surfaces can be arranged on a coupling surface, i.e. a contact surface for mechanical contact during coupling, of the first charging interface for coupling to a coupling surface of the second charging interface.

The contact pins can be designed as elongated pin elements which are designed at one contact end for making contact with the charging contacts of the first charging interface. In this case, the contact end can have a convexly curved contact surface and, in particular, can be designed at least partially as a dome. The contact pins can be movably mounted in the second charging interface and, in particular, can be arranged so as to be displaceable in the longitudinal direction of the contact pins. The individual contact pins can be designed identically. It is also conceivable that the contact pins are designed differently, in particular, for example, that the outer contact pins are thinner and/or longer than the central contact pin. In particular, the contact ends of the contact pins can be arranged at the same height in the connection direction or at different heights, whereby, for example, an uneven distance to the corresponding charging contacts of the first charging interface can be compensated.

The at least two outer contact pins of the second charging interface are each arranged at an equal distance from the central contact pin and thus lie on an imaginary circle around the central contact pin. The radius of the imaginary circle may correspond to the radius of the contact ring of the first charging interface, so that a distance of the at least two outer contact pins from the central contact pin of the second charging interface corresponds to a distance of the outer charging contact or contacts from the central charging contact of the first charging interface. In this way, the contact pins are positioned in such a way that the outer contact pins are arranged in the area of the contact ring, i.e. the outer charging contact or outer charging contacts, of the first charging interface when the central contact pin contacts the central charging contact of the first charging interface. In further embodiments, there may be three, four or more outer contact pins, which are each arranged at the same distance from the central contact pin.

In one embodiment, the second charging interface comprises exactly three contact pins, i.e. the central contact pin and two outer contact pins. The three contact pins can be arranged in a row next to each other, with the two outer contact pins being arranged on either side of the central contact pin. In this way, with an unevenly interrupted contact ring, in particular also with a triple interrupted contact ring, it can be ensured, with uniform distribution of the interruptions, that with a relative rotation of the two coupled charging interfaces about an imaginary axis, which is defined by a longitudinal defined by a longitudinal axis of the central contact pin, at least one of the two outer charging contacts of the second charging interface can always be electrically contacted with at least one of the outer charging contacts of the first charging interface when the central contact pin is electrically contacted with the central charging contact of the first charging interface.

In one embodiment, the charging arrangement comprises a holding device which is designed to couple the first charging interface to the second charging interface in a releasable manner in the plurality of coupling positions. The holding device can be designed in such a way that the first charging interface can be coupled to the second charging interface in a plurality of different relative rotational positions.

In one embodiment, the holding device comprises a permanent magnet on the first charging interface, which is designed to magnetically interact with a complementary permanent magnet or an element made of a magnetizable material of the second charging interface. Due to the magnetic holding force provided by the permanent magnet, a releasable coupling of the first charging interface to the second charging interface can be achieved. The permanent magnet may comprise a magnetic ring or be formed as a magnetic ring. This achieves the effect that an effective holding force can be distributed over a comparatively large area with little material expenditure. In one embodiment, the magnetic ring runs around the outside of the contact ring of the first charging interface. “Outside” refers to the axis of symmetry of the contact ring, with respect to which the magnetic ring runs around the contact ring in a radial direction on the outside. In this way, a diameter of the magnetic ring can be chosen independently of a diameter of the contact ring, to a large extent freely, in particular larger. The large diameter of the magnetic ring that can be achieved in this way enables a particularly stable mounting (resistance to tilting), in which the effective holding force can be distributed over as large an area as possible. In certain embodiments, the magnetic ring is axially magnetized with respect to its axis of symmetry. On the one hand, this enables a high magnetic holding force in a comparatively small design and, on the other hand, provides a holding force that is independent of the rotational position around the axis of symmetry of the magnetic ring.

In one embodiment, the holding device comprises a permanent magnet at the second charging interface, which is designed to interact magnetically with a complementary permanent magnet, in particular the permanent magnet of the holding device at the first charging interface, which is designed as a magnetic ring, or with an element made of a magnetizable material of the first charging interface. The permanent magnet at the second charging interface can largely comprise a magnetic ring or be designed as a magnetic ring, analogously to the permanent magnet of the holding device at the first charging interface. In one embodiment, the magnetic ring encircles the contact pins of the second charging interface on the outside. “Outside” here refers to a longitudinal axis of the central contact pin, with respect to which the magnetic ring encircles all contact pins together, in a radial direction on the outside. In this way, a diameter of the magnetic ring can be chosen largely freely, in particular larger than a maximum distance between two of the contact pins, independently of the arrangement of the contact pins. In certain embodiments, the magnetic ring is axially magnetized with respect to its axis of symmetry. The advantages of the mentioned embodiments correspond mutatis mutandis to the advantages mentioned in connection with the permanent magnet of the first charging interface.

In one embodiment, the holding device has a permanent magnet in the form of a magnetic ring at both the first and second charging interfaces. The two permanent magnets in the form of magnetic rings can have the same diameter. When the first and second charging interfaces are coupled, the axes of symmetry of the magnetic rings coincide and correspond to the connection direction of the charging arrangement. The magnetic rings can have cross-sectional areas corresponding to one another with respect to the connection direction of the charging arrangement, so that there is maximum overlap of the rings when the first charging interface is coupled to the second charging interface. The magnetic rings of the holding device ensure that the first and second charging interfaces are correctly positioned relative to one another when the charging assembly is coupled. In particular, the magnetic rings interact in such a way that their respective axes of symmetry are aligned largely coaxially.

In one embodiment, at least one or more of the contact pins is/are spring-loaded. In particular, all contact pins can be spring-loaded. In this context, a spring-loaded mounting can refer to a mounting of a contact pin in which the contact pin is arranged in the second charging interface so that it can be displaced in its longitudinal direction and a spring force is applied to this direction. In other embodiments, the contact pin can be pivotally mounted and subjected to a spring force. Similarly, the contact pin can be designed as a spring arm, which is anchored at one of its longitudinal ends in the second charging interface. Due to the spring-loaded mounting, the at least one or more contact pins can be pressed against the charging contacts of the first charging interface by the spring force when the first charging interface is coupled.

Since the permanent magnets, which are designed as rings, can be designed with a comparatively large diameter and axially magnetized, the magnetic holder can provide a comparatively large magnetic holding force. This makes it possible for all three contact pins to be spring-loaded without the magnetic coupling of the first and second interfaces being significantly affected by the comparatively large common counterforce of the spring-loaded contact pins. Ultimately, this can enable more reliable and better contact with reliably coupled charging interfaces.

In one embodiment, the contact ring, which is interrupted at least once, is formed on a continuous carrier ring, so that the one or more outer charging contacts are connected to one another via the carrier ring. The carrier ring and the contact ring can have the same diameter and be coaxial. The outer charging contacts formed by the contact ring can thus form crenellated projections on the carrier ring. In particular, the carrier ring and the contact ring can be formed in one piece.

In one embodiment, on the side opposite the contact ring in the axial direction of the carrier ring, there are one or more projections that protrude in the axial direction of the carrier ring and are designed to engage in corresponding recesses on a wiring carrier and be soldered there. A wiring carrier is a mechanical carrier with line structures for wiring electronic components, such as a printed circuit board. The projections can be formed integrally with the carrier ring and, similar to the outer charging contacts, can form crenellated projections on the carrier ring.

The charging arrangement may be implemented as a system comprising a hearing aid and a charger. The charger can comprise either the first or the second charging interface of the charging arrangement, while the hearing aid comprises the other charging interface of the charging arrangement. In an embodiment, the first charging interface is formed on a hearing aid and the second charging interface is formed on a charger. The first charging interface can be arranged on and/or in an outer side of a cover plate of the hearing aid. Likewise, the first charging interface can be arranged on and/or in an outer side of a housing wall of a housing shell of the hearing aid. The charging contacts can be embedded in the cover plate or in the housing wall of the hearing aid, whereby a contact surface of the charging contacts, i.e. a surface provided for making contact with the pin contacts of the second charging interface, is exposed on the outside of the cover plate or the housing wall, i.e. is accessible from the outside. In particular, the charging contacts can also project beyond the outside of the cover plate or the housing wall. In one embodiment, the charging contacts can be arranged on the outside, e.g. as conductor tracks or surfaces. The cover plate or the housing wall can be made of plastic, for example.

In a further embodiment, one or more sealing elements made of an elastomer are arranged against the cover plate to seal the charging contacts. It is understood that in embodiments in which the first charging interface is formed in a different area of the hearing aid, such as on and/or in an outer side of a housing wall of the hearing aid, one or more elastomer sealing elements can be arranged analogously.

In one embodiment, the one or more sealing elements are each in the form of O-rings, with one of the sealing elements being arranged around the central charging contact. In one embodiment, one of the sealing elements can be arranged around the outside of the contact ring or, if present, around the outside of the carrier ring and/or one of the sealing elements can be arranged around the inside of the contact ring or, if present, around the inside of the carrier ring. In particular in the case of a carrier ring, the corresponding sealing elements can rest against the carrier ring continuously, thus ensuring a complete seal on an inner side and an outer side of the carrier ring.

Further described herein is a hearing aid for a charging arrangement, wherein the hearing aid comprises a charging interface designed for detachable coupling with a charging interface of a charger. In this case, the charging interface of the hearing aid can have several charging contacts, which comprise an at least once interrupted contact ring that forms one or several outer charging contacts, and which have a central charging contact that is arranged in a central area of the contact ring. In other words, the charging interface of the hearing aid can be designed as the first charging interface of the charging arrangement. Alternatively, the charging interface of the hearing aid has contact pins, which comprise a central contact pin and at least two outer contact pins arranged at the same distance from the central contact pin. In other words, the charging interface of the hearing aid can be designed as the second charging interface of the charging arrangement.

In an embodiment, the charging interface of the hearing aid has the plurality of charging contacts for making electrical contact with contact pins of the charging interface of the charger, i.e. the first charging interface of the charging arrangement. The first charging interface of the charging arrangement can be designed to be more compact and space-saving than the second charging interface. It is therefore advantageous to form the first charging interface in or on the hearing aid, where miniaturization is essential. In this case, the second charging interface is formed in or on the charger.

The charging interface of the hearing aid can be arranged in and/or on an outer side of a cover plate or a housing wall of a housing shell of the hearing aid. Further embodiments of the charging interface of the hearing aid can be found in the present description of the charging arrangement.

Embodiments described herein also relate to a charging device for a charging arrangement, whereby the charging device comprises a charging interface for charging a hearing aid, which is designed for the detachable mutual coupling with a charging interface of a hearing aid. The charging interface of the charger can either have several charging contacts, which comprise an at least once interrupted contact ring and which have a central charging contact that is arranged in a central area of the contact ring. The contact ring forms one or more outer charging contacts as described. In other words, the charging interface of the charger can be designed as the first charging interface of the charging arrangement.

Alternatively, the charging interface of the charger has contact pins, which comprise a central contact pin and at least two outer contact pins arranged at the same distance from the central contact pin. In other words, the charging interface of the charger can be designed as the second charging interface of the charging arrangement.

In an embodiment, the charging interface of the charger has the plurality of contact pins for making electrical contact with charging contacts of the charging interface of the hearing aid, i.e. the second charging interface of the charging arrangement forms the charging interface of the charger. Further embodiments of the charging interface of the charger can be derived from the present description of the charging arrangement. The hearing aid intended for charging with the charger can in particular be a hearing aid as described herein, which may comprise the other charging interface of a charging arrangement.

The charger can be designed as a conventional charger and at the same time serve as a storage container for the hearing aid(s). In the present case, reference is made to several hearing aids, which also includes a single hearing aid, unless explicitly stated otherwise. Such chargers typically have one or more compartments for holding the hearing aids. For better protection during storage, the hearing aids are usually completely enclosed in the compartment(s) when used with such chargers. The charging interfaces of such a charger are arranged in the storage compartment(s) so that the hearing aids, when arranged as intended, can be coupled with their charging interfaces to the charging interfaces of the charger. The storage compartment(s) can be closed, for example, by a lid so that the hearing aids can be stored completely enclosed and protected. If there are two separate compartments, e.g. one for each hearing aid, these can be closed individually or with a common lid. Such conventional chargers are not very portable due to the size of the charger, which is typically determined by the fully enclosed or closable compartments, and are therefore often intended for stationary use.

Embodiments described herein also propose a portable charger that is designed primarily for the temporary connection of one or more hearing aids for charging purposes, without a storage function. The portable charger can be characterized by the fact that there are no enclosed spaces for holding the hearing aids. The charging interface(s) of the charger can be designed to be free-standing, e.g. on a charging post, on the charger, so that the hearing aids can be coupled to the charger with free access. However, simple charging wells can also be provided, in which a charging interface of the charging arrangement is arranged and into which the hearing aids can be partially inserted. The charger can thus be comparatively compact, which increases portability and allows for easier storage, e.g. in a handbag or jacket pocket. Since there is no need for enclosed receiving spaces, in particular no lids for closing, there are no or only very few shape requirements with regard to the hearing aids that can be charged by such a charger. The portable charger is therefore versatile and can be used in particular for numerous hearing aids of different designs with different external shapes and sizes.

The portable charger can have two charging interfaces so that two hearing aids (e.g. of a binaural system) can be charged simultaneously. Alternatively, the portable charger can be designed to save space so that it can charge only a single hearing aid. This can be advantageous, for example, if the user only needs one hearing aid. It is also conceivable that several hearing aids can be charged one after the other with the portable charger with only one charging interface.

The portable charger can comprise a cable arrangement by means of which at least one coupling part of the charger, on which the charging interface is arranged, can be connected to a voltage source. The coupling part can be particularly compact in design, since, depending on the application, only one charging interface needs to be provided on it. There can be two separate coupling parts, each with a charging interface. However, coupling parts are also conceivable in which two charging interfaces are provided. The cable arrangement may comprise a cable that is firmly attached to the coupling part or parts and can be connected to a voltage source via a USB interface (also referred to herein as a “USB voltage source”). Conventional USB, USB-C, mini or micro USB plug connections are conceivable, for example. The cable can also be connected to the coupling part(s) via a suitable plug connection, e.g., also a USB connection, i.e. e.g. a conventional USB, USB-C, mini or micro USB connection. Alternatively, the charger may also have means for wireless power supply, so that the charger or the coupling part(s) of the charger can be supplied via a corresponding wireless power source. Likewise, the charger or the coupling part can have a fold-out plug that allows the charger or the coupling part to be plugged directly into a domestic socket without the need for a cable assembly.

The charger can have a separate power supply unit that serves as a voltage source. The power supply unit can be plugged into a conventional domestic socket or into an on-board socket of a vehicle, for example. However, the charger can also be connectable to a USB voltage source, which can be provided, for example, by a power pack or a mobile device such as a smartphone, etc. If the charger has a cable assembly, it is designed accordingly in this case. However, the charger or the coupling part can also have an integrated power supply unit and display means such as indicator lights (e.g. LEDs) or a screen can be integrated into the charger or the coupling part. If necessary, the charger or coupling part can have operating elements such as buttons, push buttons, sliders or touch-sensitive areas such as a touchpad. In the case of a display screen, this can be touch-sensitive and designed as a touchscreen. Any components of a charging electronics system can also be integrated into the charger, e.g. in the coupling part.

The indicator lights of the charger and/or the docking station, if present, may have, for example, multi-colored indicator lights, so that different colors can be used to indicate, for example, the charge status of the respective hearing aid and/or/or a status of the charging process (e.g. “red”: for charging state: critical-charging; “yellow”: charging state: medium-charging; “green”: charging state: fully charged-not charging). Of course, several single-color indicator lights can also be provided, e.g. in different colors, which can provide information about the charging state or process. The indicator lights can be designed as conventional LEDs or incorporated as design elements into the shape of the coupling parts. In particular, the indicator lights can be designed as ring lights, for example, which can be attractively integrated into a circular cylindrical base body of the coupling parts. Ring lights have the advantage that they are visible from all sides and thus can hardly be overlooked.

A charging electronics, in particular, but not only in the case of the mobile charger, can include a protective circuit that can be used to determine whether a hearing aid is coupled to the charging interface(s) or not. The protective circuit can be designed in such a way that the charging contacts are de-energized when no hearing aid is connected. This way, short circuits with keys or other metal objects can be avoided, which is advantageous for a mobile charger, since it can be used in circumstances that are difficult to control and transported in a handbag, for example.

However, mechanical solutions are also conceivable to prevent short circuits. For example, the charging interfaces of the charger can be designed in such a way that the charging contacts can be retracted or withdrawn so that they are no longer accessible from the outside when the charger is not in use. For this purpose, simple mechanical lifting and lowering devices are conceivable, which allow the charging contacts to be retracted into the housing, e.g. into a charging post of the charging interface. This can be done manually using a mechanical operating lever or automatically using an electric actuator, for example, which can be controlled by the protective circuit mentioned above.

In another mechanical solution for protecting the charging contacts, the charger can also have attached or integrated protective caps or storage spaces with (or in) which the charging interfaces can be covered (or stored) when the charger is not in use. This allows the contacts of the charging interface to be protected against short circuits and/or contamination, in particular with magnetizable particles, for example.

The coupling parts of a charger can also be designed to be attached to each other. For example, the coupling parts can be magnetically or snap-fitted to one another in such a way that the charging interfaces are mutually protected in the connected state. For this purpose, the coupling parts can, for example, have receiving spaces in which the charging interface of the other coupling part can be accommodated when they are attached to one another. The charging interfaces and the receiving chambers can have means such as, for example, locking notches and/or locking projections, which enable and secure the mutual fastening. In the case of magnetic fastening, magnetizable or magnetic elements can be present, which can interact, for example, with magnets of the charging interfaces that are present anyway.

However, it may also be advantageous to attach two coupling parts to each other, for example, to connect the two largely loose coupling parts to form a single unit for storage, i.e. even without the intended protective function of the charging interfaces.

In one embodiment, the cable assembly can comprise an electronics unit, e.g. in the form of an electronics module, which includes the display means and/or operating elements and/or charging electronics. The advantage of the electronic unit is that, for example, the charging electronics of the charger or display elements do not need to be arranged in the coupling unit, which can therefore be designed with a comparatively small size.

The electronic unit of the cable assembly or the coupling part(s) can have an integrated battery that allows the charging of the hearing aid(s) without connecting the charger to a power source. The battery can be charged, for example, via an external power source, e.g. via the cable assembly or via means for contactless power supply, which can be integrated, for example, into the electronic unit or into the coupling part. The portable charger can be designed to charge the hearing aid(s) only from the battery. The battery can be charged when the charger is connected to an external power source. Similarly, the charger can also be designed only to charge the hearing aids from an external power source, i.e. no battery needs to be present. Of course, hybrid forms are also conceivable in which the hearing aids and the battery are charged simultaneously from an external power source.

In one embodiment, the charger comprises two separate coupling parts, on which a charging interface for charging a hearing aid is arranged. In this case, the cable assembly may include a Y-cable, via which the two coupling parts can be connected to a voltage source. In the case of a Y-cable, the aforementioned electronic unit can be formed as a branching piece at the branching of the cable. Alternatively, each of the coupling parts can be supplied by a voltage source via a separate linear cable, or the coupling parts are connected in series to the voltage source via a cable, i.e. only one cable runs from the charging electronics to one of the coupling parts and is then looped off from this to the second coupling part.

Since there are two separate coupling parts, these can be designed to be particularly simple and small. This makes it easy to store the charger, which is particularly important for a portable charger. The charging arrangement, in particular in an embodiment with a magnetic ring as a holding device, allows easy and flexible coupling of the hearing aids. This is particularly advantageous for a portable charger that is not always used under ideal circumstances and should therefore be easy and flexible to use.

For other applications, e.g. when a user requires only one hearing aid or the mobile charger is to be used only as an emergency charger for several hearing aids, the charger can also comprise only a single coupling part. This can, for example, comprise a battery that can be charged via a connectable cable or wirelessly. The portable charger, which is particularly compact in design, can then be easily connected to a hearing aid to fully or partially charge it. Such a portable charger can be designed to save a lot of space.

One side of the coupling part on which the charging interface is designed is referred to in the present case as the usage side. A side of the coupling part opposite the use side is referred to herein as the underside. The underside can form a mounting surface or a standing surface with which the coupling part can be mounted on a surface. In particular, the coupling part can be placed on a horizontal surface. Since the coupling part can have only a low dead weight, the mounting surface can have additional fastening means for temporary fastening on the base. Such fastening means can, for example, comprise a suction cup or the underside can have a circumferential sealing lip that acts as a suction cup. Likewise, magnetic fasteners can be present that allow temporary attachment to a magnetic surface. This ensures that the coupler and thus the hearing aids coupled to it are aligned in a way that supports the coupling provided by the charging arrangement.

In a further embodiment, the at least one coupling part can be designed as a base plate on which two charging interfaces for charging one hearing aid each are arranged. The charging interfaces can be formed on a socket protruding from the base plate. The charging interfaces may be formed on the same side of the base plate. The two charging interfaces allow two hearing aids to be coupled simultaneously to the coupling part designed as a single base plate.

Due to the slightly larger size of the coupling part designed as a base plate with two charging interfaces, further structures may be formed on the coupling part. For example, there may be a space for the cable arrangement. This can be provided along a circumference of the base plate as a receiving notch in which a cable of the cable arrangement can be wound along the circumference. Similarly, the base plate can have a winding space on the underside, in which the cable can be wound up completely or partially. The cable can then be unwound to a desired length as required.

The base plate can also have fasteners on the edge of the base plate so that it can be attached to the side of a vertical surface, e.g. in the manner of a shelf. It is also conceivable that magnets are provided on the side, for example, to allow the base plate to be temporarily attached to a refrigerator door.

The base plate can also include integrated tools such as cleaning and/or maintenance tools for the hearing aids. In particular, the base plate of the charger can have a fold-out tool. Likewise, the base plate can have a temporarily detachable tool. For this purpose, the base plate can have corresponding receiving spaces for the tools, from which the tools can be removed and reinserted (temporarily detachable tool), for example, or into which or from which the tools can be folded in or out (fold-out tool).

In one embodiment, the hearing aid is configured as an in-the-ear hearing aid. It is also possible for the hearing aid to be designed as a behind-the-ear hearing aid or as another type of hearing aid.

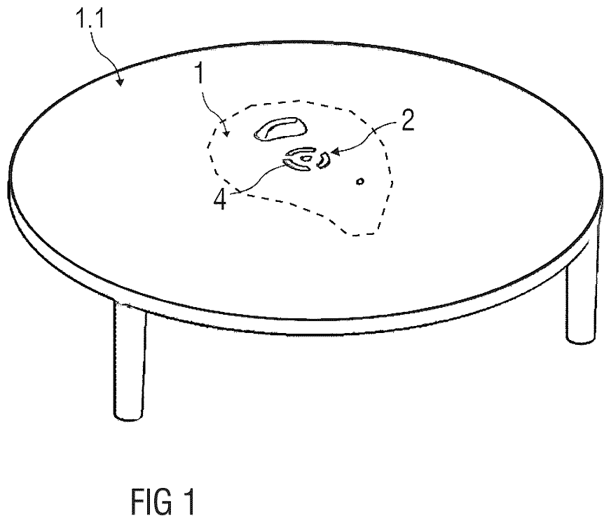

FIG. 1 is a schematic view of a cover plate blank 1.1 of a cover plate 1 (also called a “faceplate”) for a hearing aid, in particular an in-the-ear (ITE) hearing aid, which is provided with a rechargeable voltage source. The cover plate 1 is cut out of the cover plate blank 1.1 (indicated by a dashed line) and can thus be adapted, for example, to a custom-shaped housing shell of the hearing aid. A first charging interface 2, which has charging contacts, is arranged on and/or in an outer side of the cover plate 1 for charging the voltage source. In particular, an at least once interrupted contact ring 4 is present in some examples.

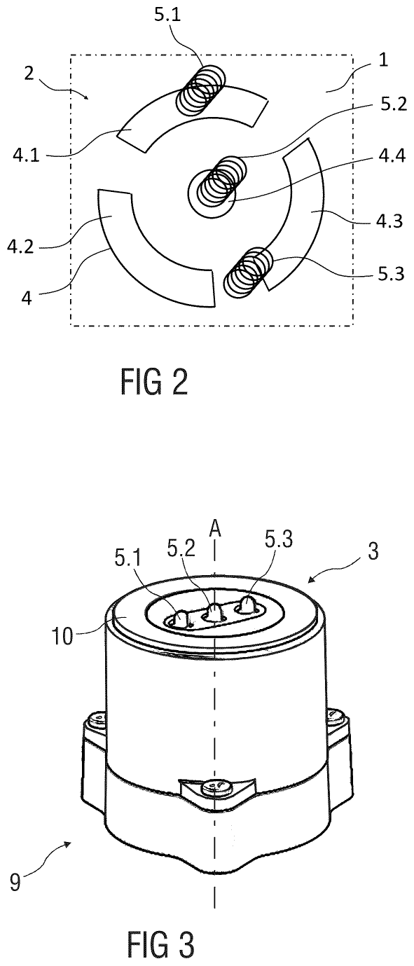

FIG. 2 shows a schematic view of the first charging interface 2 in a plan view of the cover plate 1. The charging contacts 4.1, 4.2, 4.3, 4.4 of the first charging interface 2 are arranged on and/or in the cover plate 1. Three separate outer charging contacts 4.1 to 4.3 are formed by the contact ring 4, which is interrupted at three points. The contact ring 4 is in the form of a circular ring, so that the charging contacts 4.1, 4.2, 4.3 are in the form of sectors of a circular ring. The interruptions are uniformly distributed over the circumference of the contact ring 4, so that the charging contacts 4.1, 4.2, 4.3 are of equal size.

Furthermore, a central charging contact 4.4 is arranged in the area of a center of the contact ring 4. The charging contacts 4.1 to 4.4 can be embedded in the cover plate 1 or, in other embodiments, in a wall of a housing shell, which is formed, for example, from plastic. Due to the interruptions of the contact ring 4, which separate the charging contacts 4.1 to 4.3 from one another, the cover plate 1 can be designed to be continuous between the charging contacts 4.1 to 4.3 and thus, at least in this area, can be molded in one piece.

A plurality of thinly extended circles in FIG. 2 indicate contact pins 5.1 to 5.3 of a second charging interface 3 of a charging device 9 in different positions relative to the first charging interface 2. The charging interface 3 is shown, for example, in FIG. 3.

FIG. 3 is a schematic detailed view of the charger 9 with the second charging interface 3 configured to contact the first charging interface 2 of the hearing aid to charge the rechargeable power source of the hearing aid.

The second charging interface 3 on the charger 9 comprises three contact pins 5.1, 5.2, 5.3, which may, for example, be arranged in a row next to each other. Furthermore, at least one or more of the contact pins 5.1 to 5.3, or all contact pins 5.1 to 5.3, may be spring-loaded. Other arrangements of contact pins 5.1 to 5.3 may also be used, such as a rectangular arrangement with three contact pins or a cross-shaped arrangement with five contact pins, for example. It is important that the outer contact pins 5.1 and 5.3 are each the same distance from the central contact pin 5.2, i.e. they are arranged on an imaginary circle around the central contact pin 5.2. The distance of the outer contact pins 5.1 and 5.3 from the central contact pin 5.2 corresponds to the radius of the contact ring 4 of the first charging interface 2.

At least two electrical poles are required to charge the hearing aid in order to apply a voltage and allow a current to flow. These are formed by the central contact pin 5.2 in the center, which can make electrical contact with the central charging contact 4.4 when coupled, and the two outer contact pins 5.1, 5.3 on either side of the central contact pin 5.2, which contact ring 4 always makes contact with one of the charging contacts 4.1 to 4.3 of the first charging interface 2 at at least one point.

In one embodiment, the contact ring 4 can also be interrupted at only one point or at another uneven number of points. In a further embodiment, the contact ring 4 can be interrupted at two points or at another even number of points, in particular such that the interruptions are not uniformly distributed over the circumference of the contact ring 4, so that the resulting even number of charging contacts are not of equal size. The contact ring can also be interrupted at an even number of points with equally sized charging contacts, in which case the contact pins must not be arranged in a row to ensure electrical contact.

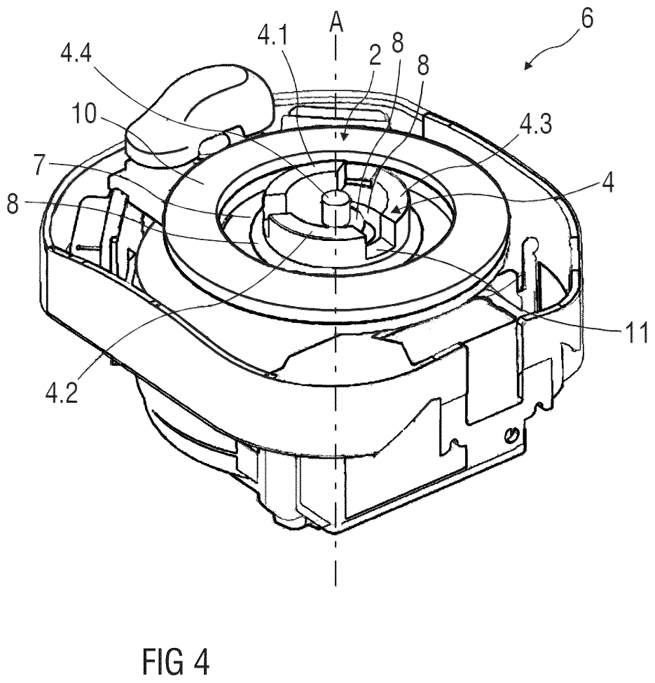

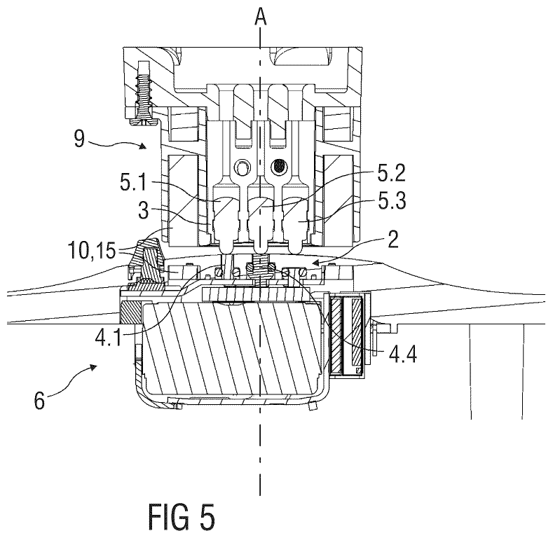

FIG. 4 is a schematic detailed view of the hearing aid 6 with the first charging interface 2, whereby the cover plate 1 and a housing shell of the hearing aid 6 are not shown. The contact ring 4 forms three charging contacts 4.1 to 4.3, which are arranged on a carrier ring 11 (see also FIG. 5). The charging contacts 4.1 to 4.3 of the contact ring 4 thus form projections on the carrier ring 11, which are designed as sectors of a cylindrical ring with circular cylinders and extend in a “crenellated” manner in an axial direction of the carrier ring 11, i.e. parallel to an axis of symmetry of the ring. The axis of symmetry of the carrier ring 11 and the contact ring 4 corresponds to the axis A shown in FIG. 4.

The charging contacts 4.1 to 4.3 are thus connected to one another throughout the hearing aid 6 via the carrier ring 11 and can be electrically and/or mechanically connected, for example soldered, to a wiring carrier 7, for example a printed circuit board. In this way, a charging current supplied via the charging contacts 4.1 to 4.3 can be passed on via the carrier ring 11 to the wiring carrier 7 and from there to the rechargeable voltage source of the hearing aid 6. One or more sealing elements 8, for example elastomer parts, in particular O-rings, can be provided to seal the charging contacts 4.1 to 4.3 in order to prevent or hinder the penetration of dirt into the hearing aid 6.

In one embodiment, at least one permanent magnet 10 is arranged on the hearing aid 6, which is configured to magnetically interact with at least one complementary permanent magnet 10 or at least one element made of a magnetizable material on the charger 9, in order to couple the charger 9 to the hearing aid 6 in a releasable manner during the charging process that both the central contact pin 5.2 is in electrical contact with the central charging contact 4.4 and at least one of the outer contact pins 5.1 or 5.3 is in electrical contact with at least one of the outer charging contacts 4.1 to 4.3 of the contact ring 4.

In one embodiment, at least one permanent magnet 10 is arranged on the charger 9, which is configured to interact magnetically with at least one complementary permanent magnet 10 or at least one element made of a magnetizable material on the hearing aid 6, in order to couple the charger device 9 to the hearing aid 6 in a securely detachable manner during the charging process, such that the contact pins 5.1 to 5.3 are or remain in electrical contact with at least some of the charging contacts 4.1 to 4.4.

The permanent magnets 10 can each be designed as a magnetic ring and form parts of a holding device 15 for the releasable mutual coupling of the first charging interface 2 and the second charging interface. In this case, it can be provided that the permanent magnet 10 designed as a magnetic ring on the charger 9 runs around all three contact pins 5.1 to 5.3 on the outside. Furthermore, it can be provided that the permanent magnet 10 designed as a magnetic ring on the hearing aid 6 runs around the contact ring 4 or the carrier ring 11 on the outside. Due to the external arrangement, a diameter of the magnetic rings can be selected independently of the size of the contact ring 4 or a relative distance of the contact pins 5.1 to 5.3. In particular, this allows for a comparatively large diameter of the permanent magnets 10, which in turn ensures a particularly stable mounting (resistance to tilting).

According to one embodiment, the two permanent magnets 10 in the form of magnetic rings can be magnetized axially with respect to an axis of symmetry of the magnetic rings, which on the one hand enables a strong magnetic holding force in a small design and on the other hand allows free mutual rotation about this axis of symmetry. This means that the hearing aid 6 does not have to be docked in a predetermined rotational position to the charger 9. The axis of symmetry of the magnetic rings corresponds to the axis A shown in FIGS. 3 to 6. It can be seen from FIG. 5 (see below) that the hearing aid 6 can be rotated around the axis A without interrupting the electrical contact (as can also be seen from FIG. 2). The various relative rotational positions of the hearing aid 6 and the charger 9 thus represent different coupling positions in which the hearing aid 6 and the charger 9 can be coupled to charge the hearing aid 6.

In particular, in the case of embodiments with the permanent magnets 10 designed as magnetic rings, it may be provided that all three contact pins 5.1 to 5.3 (instead of, for example, only one of the contact pins 5.1 to 5.3) are spring-loaded, since a greater counterforce can be overcome with the axially magnetized magnetic rings and their comparatively large diameter. This ultimately enables a better contact with a simultaneously reliable holding.

The sealing elements 8 can each be designed as O-rings, where one of the sealing elements 8 can be arranged around the central charging contact 4.4 and another of the sealing elements 8 can be arranged around the contact ring 4 in a circulating manner. Another of the sealing elements 8 can be arranged in a circulating manner on the inside of the contact ring 4.

FIG. 5 is a schematic view of the charger 9 with the hearing aid 6, wherein the first charging interface 2 is coupled to the second charging interface 3. The magnetic rings of the permanent magnets 10 exert an attractive force which, as a holding force, couples the two charging interfaces 2 and 3 to one another. In the process, the contact pins 5.1 to 5.3 are pressed against the charging contacts 4.1 to 4.4.

The axis A drawn in FIGS. 3 to 6 also corresponds to a connection direction of the two charging interfaces 2 and 3, i.e. a direction in which the two charging interfaces 2 and 3 can be brought together as intended for coupling.

The contact pins 5.1 to 5.3 are movably mounted in their respective longitudinal direction and are spring-loaded by springs (not shown) in the charger 9 or in the second charging interface 3. The longitudinal direction of the contact pins 5.1 to 5.3 corresponds to the direction of the illustrated axis A. The contact pins 5.1 to 5.3 have rounded contact ends, which are arranged on corresponding contact surfaces of the charging contacts 4.1 to 4.4 and are pressed against them, so that electrical contact is ensured.

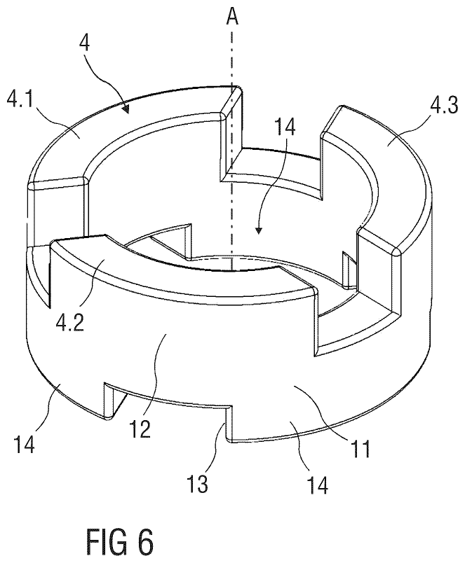

FIG. 6 shows a schematic view of an embodiment of the contact ring 4. The contact ring 4 is arranged on the carrier ring 11, which is completely uninterrupted all around. The contact ring 4 thus forms an upper section 12 of the arrangement shown in FIG. 6, with the charging contacts 4.1 to 4.3 being designed in the form of axial projections on the carrier ring 11. The uninterrupted carrier ring 11 carries the charging contacts 4.1 to 4.3 formed by the interrupted contact ring 4 and connects them to one another in an electrically conductive manner. The carrier ring 11, with its continuous inner and outer surfaces, also serves as a contact surface for the corresponding sealing elements 8. The carrier ring 11 is usually arranged inside the hearing aid 6, while the charging contacts 4.1 to 4.3 project through, for example, the cover plate 1 or a housing wall and terminate, for example, on the outside of these or project slightly beyond them.

On the side of the carrier ring 11 that is opposite the upper section 12 in the axial direction, an additional lower section 13 can be formed, which is formed by projections 14 that extend in the opposite direction with respect to the charging contacts 4.1 to 4.3. The projections 14 can be configured to engage in corresponding recesses on the wiring carrier 7 and be soldered there.

The arrangement shown allows the rechargeable hearing aid 6, in particular an in-the-ear hearing aid, to be docked for charging at any angle about the axis A, which corresponds to a connection direction in the present case, relative to the charger 9, without contacting or holding of the hearing aid 6 being impaired. The end customer does not have to pay attention to the angle of rotation with respect to the connection direction when guiding the hearing aid 6 to the charger 9.

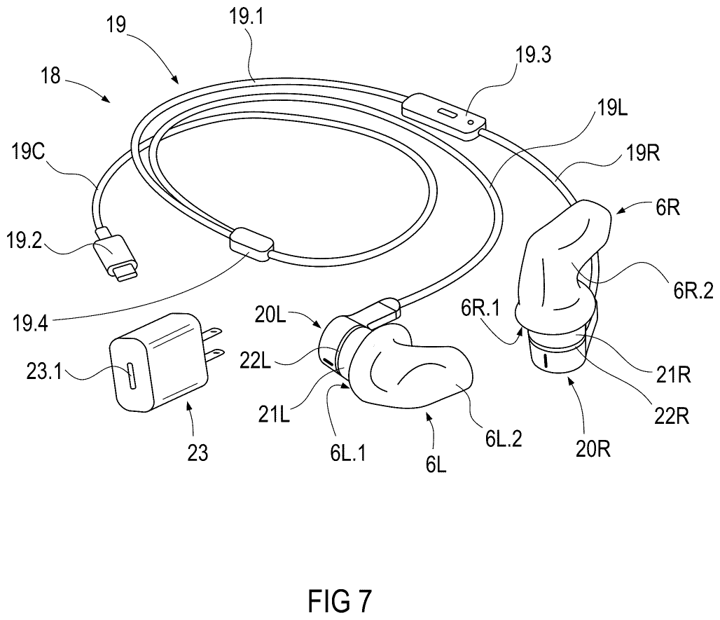

FIG. 7 shows a schematic view of a charging cable 19 of a portable charger 18 comprising a charging interface of a charging arrangement.

The charging cable 19 comprises a cable arrangement 19.1 in the form of a Y-cable having a base cable section 19C which branches at a branching point 19.4 into a first cable section 19R and a second cable section 19L. A coupling part 20R or 20L is arranged at the free end of each cable section 19R and 19L. The coupling parts 20R and 20L each have a largely circular-cylindrical base body 21R and 21L and are designed for coupling a hearing aid 6R or 6L, for example of a binaural hearing system.

The hearing aids 6R and 6L each have an outer shell 6R.2 and 6L.2, respectively, which are adapted to the user's ear. The shells 6R.2 and 6L.2 can be prefabricated, partially individualized or fully customized. This can be achieved, for example, by means of additive manufacturing processes such as 3D printing.

A cover plate 6R.1 or 6L.1 corresponding to the cover plate 1 (“faceplate”) is inserted into one of the openings of the shells 6R.2 and 6L.2, in or on which the charging interface of the charging arrangement is formed. Further features of the hearing aids 6R and 6L correspond essentially to the hearing aid 6 described above in a version for a right (R) and for a left (L) ear.

The coupling parts 20R and 20L are essentially of the same design and are each provided with the second charging interface 3, which is configured to make contact with the first charging interface 2 of the hearing aids 6R and 6L in order to charge the rechargeable internal voltage source of the hearing aids 6R and 6L. It is understood that in other embodiments, the first charging interface 2 may also be formed on the coupling parts 20R and 20L, in which case the second charging interface 3 is formed on the hearing aids 6R and 6L.

The free end of the cable section 19C of the Y-cable 19.1 is provided with a plug 19.2 which is intended for connection to an external power supply. Typically, the plug 19.2 is designed as a USB plug and may comprise, for example, a USB-C, or micro-and mini-USB plug. This allows the charging cable 19 to be connected to a corresponding USB interface of an external power source, such as a conventional external power supply 23 or a computer. The external power supply 23 is shown here as an integrated plug component for connection to a domestic socket. The power supply 23 has an integrated connection socket 23.1 for the plug 19.2 for connecting the charging cable 19.

In the illustration of FIG. 7, the hearing aids 6R and 6L are coupled to the coupling parts 20R and 20L, respectively, for the purpose of charging. The permanent magnet ring(s) 10 or the elements made of a magnetizable material of the respective charging interfaces 2 and 3 hold the hearing aids 6R and 6L in the coupled state as described above. In this case, the contact pins 5.1 to 5.3 of the second charging interface 3 are in electrical contact, as described above, with at least some of the charging contacts 4.1 to 4.4 of the respectively coupled charging interface 2.

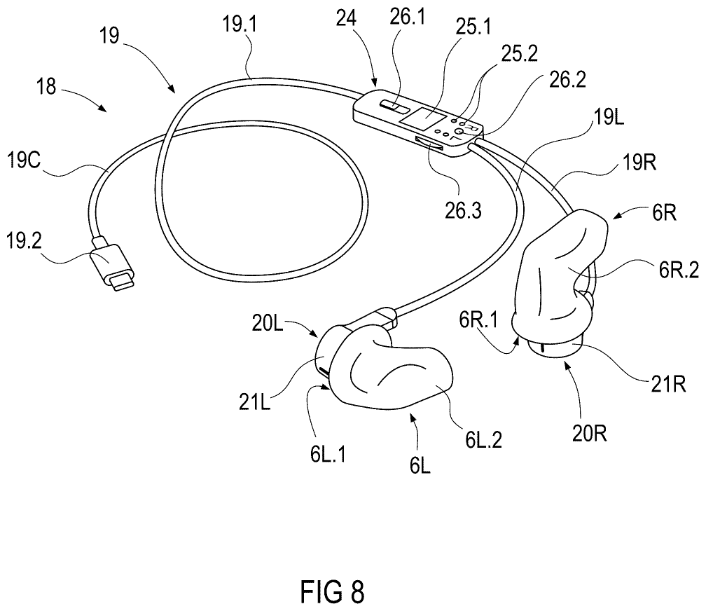

In the embodiment of FIG. 7, a charging electronic circuit of the portable charger 18 is accommodated in the respective coupling parts 20R and 20L. A charging indicator, for example in the form of a ring light 22R and 22L, for example with multicolored lighting options, can also be formed on the cylindrical base body 21R and 21L (for example “red” for charging in progress and “green” for charging completed). Furthermore, operating elements can also be provided on the coupling parts 20R and 20L, via which, for example, a charging process can be controlled and/or inputs can be made for transmission to the hearing aids 6R and 6L. The Y-cable 19.1 can include an operating unit 19.3, e.g. on one or two (not shown) of the cable sections 19R, 19L, or on the cable section 19C (also not shown), on which operating elements or display means can be provided. The operating unit 19.3 can also be designed at the branching point 19.4 as a branching piece of the Y-cable 19.1 (analogous to the electronic module of FIG. 8 described below).

FIG. 8 shows a schematic view of a further embodiment of the portable charger 18 designed as a charging cable 19. In the embodiment of FIG. 8, an electronic module 24 is arranged at the branching point 19.4 of the Y-cable 19.1, in which an electronic charging system of the charger 18 can be accommodated.

The electronic module 24 can include display means such as a screen 25.1 or different-colored or multicolored indicator lights 25.2 for displaying a charging state of the respective coupled hearing aid 6R or 6L. Likewise, input means such as operating elements can be provided, for example, to control a charging process. The operating elements may include, for example, switches 26.1, buttons 26.2 or input wheels 26.3. The display means and the input means may also be combined in a display designed, for example, as a touch screen.

It is also conceivable that the electronic module 24 is designed to communicate with the hearing aids 6R and 6L, in particular to read data from the hearing aids 6R and 6L or to transmit data to the hearing aids 6R and 6L, for example via the charging interfaces 2 and 3 or via an additional wireless interface. The read-out data can be displayed, for example, on the display means of the electronic module 24, while inputs or changes can be made via the input means of the electronic module 24, which can then be transmitted to the hearing aids 6R and 6L.

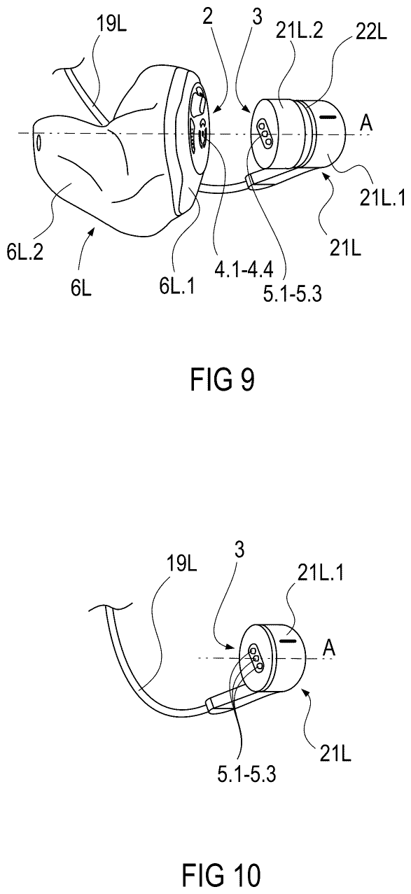

By integrating the charging electronics and any display means or operating elements in the electronic module 24, the coupling parts 20R and 20L of the charger of FIG. 8 can be designed to be comparatively compact and smaller than in the embodiment of FIG. 7. In particular, the circular cylindrical base bodies 21L and 21R can be designed to be shorter in their longitudinal direction (see also FIGS. 9 and 10). The longitudinal direction coincides here with the connection direction A of the second charging interface 3 formed on the respective coupling part 20L or 20R.

FIG. 9 shows a coupling part 20L of the charging device 18 of FIG. 7 together with the hearing aid 6L that is intended to be coupled, in a non-coupled state. The circular cylindrical base body 21L of the coupling part 20L is divided in its longitudinal direction A by the surrounding ring light 22L into two main sections 21L.1 and 21L.2. An arm extends in a lateral direction from the base body 21L, via which arm the cable section 19L of the Y-cable 19.1 connects to the coupling part 20L. In the present embodiment, the coupling part 20L comprises a charging electronic (not visible) for carrying out and/or controlling a charging process for charging the hearing aid 6L.

The second charging interface 3 is formed on an end face of the coupling part 20L. The contact pins 5.1 to 5.3 extend beyond the end face parallel to the longitudinal direction A of the base body 21L. Analogous to the representations in FIGS. 3 to 5, a permanent magnet ring 10 or an element made of a magnetizable material is arranged (not visible) in the coupling part 20L, which runs around the outside of the contact pins 5.1 to 5.3.

The hearing aid 6L has the first charging interface 2 on its cover plate 1. The charging contacts 4.1, 4.2, 4.3, 4.4 of the first charging interface 2 are arranged on and/or in the cover plate 1. As described above, at least one permanent magnet 10 can be arranged (not visible) on the hearing aid 6L, which is configured to interact magnetically with at least one complementary permanent magnet 10 or at least one element made of a magnetizable material on the coupling part 20L.

It is understood that the description of the coupling part 20L and the hearing aid 6L also applies mutatis mutandis to the coupling part 20R and the hearing aid 6R, respectively.

FIG. 10 shows the docking piece 20L of the charger 18 of FIG. 8. The docking piece 20L of FIG. 8 has no ring light 22L. The circular cylindrical base body 21L of the coupling part 20L is therefore shorter in its longitudinal direction A than that shown in FIG. 9, and in particular has only one main section 21L.1. The comparatively smaller size of the coupling part 20L that results from this is due to the fact that, in this embodiment, the charging electronics are outsourced from the coupling part 20L to the electronic module 24 and there are also no display means on the coupling part 20L. With regard to the other features, the coupling part 20L of FIG. 10 is largely analogous to the coupling part 20L of FIG. 9.

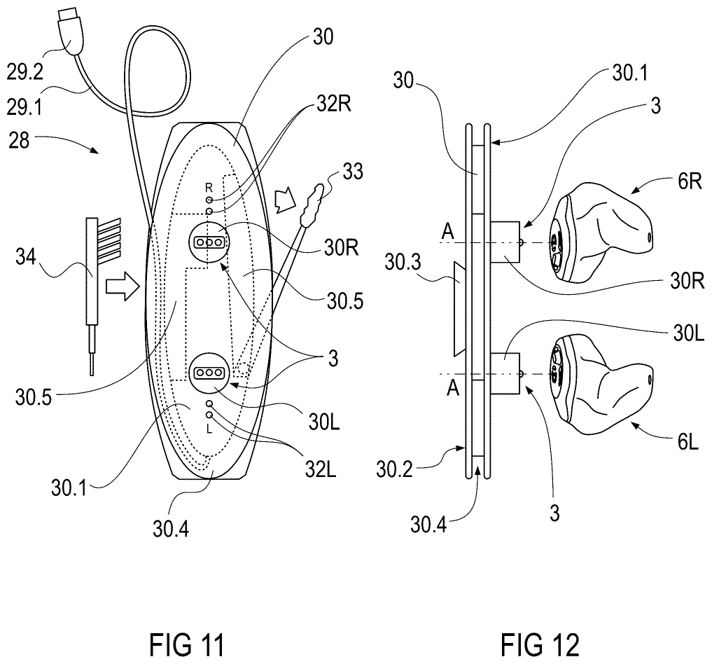

FIG. 11 shows a schematic view of a further embodiment of a portable charger 28, comprising a coupling part 30 in the form of a base plate, in a plan view. FIG. 12 shows a schematic view of the portable charger 28 of FIG. 11 in a side view. FIGS. 11 and 12 are described together below.

The charger 28 includes a cable assembly 29.1 for connecting the base plate 30 to an external power source. The cable assembly 29.1 can be permanently connected to the base plate 30 or connected to the base plate 30 via a plug connection such as a USB-C, mini or micro USB connection. At the other end, the cable assembly 29.1 has a plug 29.2 for connection to an external power source. The plug 29.2 may be a USB plug and may also comprise, for example, a USB-C, mini or micro USB plug.

The base plate 30 is provided with two second charging interfaces 3, which are configured to contact the first charging interface 2 of one of the hearing aids 6R and 6L in each case, in order to charge the rechargeable power source of the hearing aids 6R and 6L. It is understood that in other embodiments, two first charging interfaces 2 can also be formed on the base plate 30, in which case the second charging interface 3 is formed on the hearing aids 6R and 6L.

The second charging interfaces 3 are each formed on a base 30R and 30L, which project from the base plate 30 on a usage side 30.1. The bases 30R and 30L are formed largely analogously to the representation of FIG. 3 and are provided for coupling the hearing aids 6R and 6L in the connection direction A. In other embodiments, which are not shown, the charging interfaces can also be provided on or in recesses instead of bases. In this case, the hearing aids 6R and 6L can be placed in the respective recess for coupling, where the charging interfaces of the base plate 30 and the hearing aids 6R and 6L can be coupled to one another and held magnetically.

The base plate 30 has display means close to the sockets 30R and 30L, which serve, for example, to display a charging status of the hearing aid 6R or 6L coupled to the respective socket 30R or 30L. In particular, one or more indicator lights 32R and 32L, which are different colors, can be provided to indicate the charging state of the respective hearing aid 6R or 6L using different colors.

Likewise, display means 32 such as a display screen or a display means with an operating function such as a touch-sensitive touch screen can be provided (not shown). The base plate 30 can also include input means such as switches, buttons or input wheels (not shown). The base plate 30 can also include charging electronics (not shown). In particular, the functionality and/or components of the electronic module 24 described in connection with the charger 18 of FIG. 8 can be integrated into the base plate 30.

The base plate 30 may also include a rechargeable battery, for example, which can be used as a power source for charging the hearing aids 6R and 6L if, for example, no external power source is available. The base plate 30 can also have an integrated power supply (not shown) or use an external power supply such as the power supply 23, to which it can be connected via the cable assembly 29.1.

On a bottom side configured as the mounting side 30.2 opposite the use side 30.1, the base plate 30 can have a standing surface. In order to increase stability, the base plate 30 can be loaded with additional weights. Additional fastening means, such as a suction cup 30.3 or vacuum lips, can be formed on the base plate (not shown) in order to be able to temporarily fasten the base plate 30 to a smooth surface, such as a base support. Likewise, the base plate 30 can also be attached to a vertical wall. For this purpose, a lateral attachment side can be provided (not shown). Depending on the application, other attachment means, such as magnets, can be provided so that the base plate 30 can be attached to a magnetic surface.

The base plate 30 can also have a receiving space 30.4 for stowing the cable arrangement 29.1. The receiving space 30.4 is designed as a winding space for winding up the cable arrangement 29.1, so that it can be wound up completely or partially as required and thus stowed. The winding space can be formed, for example, on the underside of the base plate 30 (not shown), which is designed as a standing surface, or along a border on the circumference of the base plate 30, as shown in FIGS. 11 and 12.

Because the coupling part is designed as a base plate 30 with two charging interfaces, it has a certain minimum size. The available space can be used, for example, to provide receiving spaces 30.5 in which tools or small parts such as replacement parts and/or consumables for the hearing aids 6R and 6L can be accommodated. The tools may be intended for cleaning or other maintenance work on the hearing aids 6R and 6L. The small parts may include, for example, replaceable cerumen filters. For example, a receiving space for a replaceable dispenser for cerumen filters may be provided in the base plate 30 (not shown). The base plate 30 can also include a storage space that can be closed with a lid, in which, for example, loose small parts and/or a cleaning cloth can be stored (not shown).

The base plate 30 of FIGS. 11 and 12 comprises a fixed tool 33, which is attached by means of a swivel joint and can thus be swung into and out of a receiving space 30.5 of the base plate 30 in the manner of a Swiss army knife. The fixed tool 33 can also be designed, for example, to be telescopically extendable and retractable (not shown). Furthermore, the base plate 30 can alternatively or additionally have a further storage space 30.5 into which a tool 34 can be removably inserted. The tool 34 can be held in the further receiving space 30.5, for example, by form fit or by frictional engagement. The tools 33 and/or 34 can comprise a cleaning tool such as a cleaning brush, for example, or can also have a maintenance tool such as a screwdriver or a plunger for pressing out fixing pins on the hearing aid 6R or 6L. The tools 33 and/or 34 may also include a tool for replacing a cerumen filter on the hearing aids 6R and 6L.

What is claimed is:

1. A charging arrangement for charging a hearing aid by means of a charger, comprising:
a first charging interface and a second charging interface which are designed for releasable mutual coupling in a plurality of coupling positions; and
an indicator light configured to indicate a charging state of the hearing aid when the hearing aid is coupled to the charger;
wherein the first charging interface includes a plurality of charging contacts which comprise an at least single-break contact ring which forms one or more outer charging contacts, and which have a central charging contact which is arranged in a central region of the contact ring;
wherein the second charging interface includes contact pins which comprise a central contact pin and at least two outer contact pins arranged at the same distance from the central contact pin, the contact pins being arranged in relation to one another in such a way that, in each coupling position, the central contact pin is in electrical contact with the central charging contact of the first charging interface, while at the same time at least one of the two outer contact pins of the second charging interface is in electrical contact with at least one of the further charging contacts of the first charging interface.

2. The charging arrangement according to claim 1, wherein the charging arrangement comprises a holding device which is designed to couple the first charging interface to the second charging interface in a releasable manner in the plurality of coupling positions.

3. The charging arrangement according to claim 2, wherein the holding device comprises a permanent magnet on the first charging interface which is designed to interact magnetically with a complementary permanent magnet or an element made of magnetizable material of the second charging interface.

4. The charging arrangement according to claim 3, wherein the permanent magnet comprises a magnetic ring which runs around the outside of the contact ring and is magnetized axially with respect to its axis of symmetry.

5. The charging arrangement according to claim 4, wherein the holding device comprises a permanent magnet at the second charging interface which is designed to interact magnetically with a complementary permanent magnet or an element made of magnetizable material of the first charging interface.

6. The charging arrangement according to claim 5, wherein the permanent magnet comprises a magnetic ring which runs around the outside of the contact pins and is magnetized axially with respect to its axis of symmetry.

7. The charging arrangement according to claim 1, wherein the at least once interrupted contact ring is formed on a continuous carrier ring, so that the one or more outer charging contacts are connected to one another via the carrier ring.

8. The charging arrangement according to claim 1, wherein the first charging interface is formed on a hearing aid and the second charging interface is formed on a charging device.

9. The charging arrangement according to claim 8, wherein the first charging interface is arranged on and/or in an outer side of a cover plate or on and/or in a housing wall of a housing shell of the hearing aid and one or more sealing elements made of an elastomer are arranged against the cover plate or against the housing wall in order to seal the charging contacts.

10. The charging arrangement according to claim 8, wherein:
the charging device includes a coupling part configured to couple to the hearing device; and
the indicator light is integrated into the coupling part.

11. The charging arrangement according to claim 10, wherein the indicator light is integrated into a base body of the coupling part.

12. The charging arrangement according to claim 8, wherein the indicator light is integrated into a docking station of the charger.

13. The charging arrangement according to claim 8, wherein the indicator light is designed as a ring light.

14. A hearing aid for a charging arrangement according to claim 1, wherein the hearing aid comprises a charging interface which is designed for releasable mutual coupling to a charging interface of a charger, the charging interface of the hearing aid either
a plurality of charging contacts, which comprise an at least once interrupted contact ring that forms one or more outer charging contacts, and which have a central charging contact that is arranged in a central area of the contact ring, or
contact pins which comprise a central contact pin and at least two outer contact pins arranged at the same distance from the central contact pin.

15. A charger for a charging arrangement according to claim 1, wherein the charger comprises a charging interface for charging a hearing aid, which is designed for releasable mutual coupling with a charging interface of a hearing aid, the charging interface of the charger either:
a plurality of charging contacts which comprise an at least once interrupted contact ring that forms one or more outer charging contacts and which have a central charging contact that is arranged in a central area of the contact ring, or
contact pins which comprise a central contact pin and at least two outer contact pins arranged at the same distance from the central contact pin;
wherein the charger further comprises an indicator light configured to indicate a charging state of the hearing aid when the charging interface of the hearing aid is coupled to the charging interface of the charger.

16. The charger according to claim 15, wherein the charger comprises a coupling part on which the charging interface of the charger is integrated, and wherein the indicator light is integrated into the coupling part.

17. The charger according to claim 15, wherein the charger comprises a cable arrangement via which at least one coupling part of the charger, on which the charging interface is arranged, can be connected to a voltage source.

18. The charger according to claim 15, wherein the charging assembly comprises an electronic unit which comprises display means and/or operating elements and/or a charging electronic.

19. The charger according to claim 15, wherein the charger has two separate coupling parts, on which a charging interface for charging a hearing aid is arranged in each case, and the cable arrangement comprises a Y-cable, via which the two coupling parts can be connected to a single voltage source.

20. The charger according to claim 15, wherein the charger comprises at least one coupling part designed as a base plate on which two charging interfaces for charging one hearing aid in each case are arranged.
